(19) United States
(12) Patent Application Publication
(10) Pub. No.: US 2014/0178041 A1
(43) Pub. Date: Jun. 26, 2014

(54) CONTENT-SENSITIVE MEDIA PLAYBACK

(71) Applicant: Balakesan P. Thevar, Bangalore (IN)

(72) Inventor: Balakesan P. Thevar, Bangalore (IN)

(21) Appl. No.: 14/139,525

(22) Filed: Dec. 23, 2013

(30) Foreign Application Priority Data
Dec. 26, 2012 (IN) 5423/CHE/2012

(51) Int. Cl. G11B 27/10; H04N 9/79

(52) U.S. Cl. CPC G11B 27/10; H04N 9/79
USPC 386/241

(57) ABSTRACT

Techniques are disclosed for content-sensitive tagging of media streams and smart media playback using generated tagging-data (TD). Tagging-data (e.g., tag index and location information for each content-sensitive tag) may be generated using a smart encoding technique that may be performed by a TD-enabled encoder. In some embodiments, the smart encoding technique may be implemented, for example, as a mechanism to generate tagging-data as part of a motion-estimation engine in a graphics processing unit (GPU). Generated tagging-data may be parsed using a smart decoding technique that may be performed by a TD-enabled decoder to provide a smart media playback experience based on the content-sensitive tags. Thus, for example, a video player application can use the tagging-data to achieve a smart-video-playback experience including a content sensitive search and selective playback options. In some instances, the smart encoding and/or smart decoding techniques may be performed by a GPU.

### RELATED APPLICATION

This application claims priority to India Patent Application No. 5423/CHE/2012, filed on Dec. 26, 2012, which is herein incorporated by reference in its entirety.

### BACKGROUND

Media playback typically supports generic functions, such as playing, pausing, stopping, rewinding, and forwarding. Advanced functions have also been developed, such as zooming, audio channel selection, and subtitle selection. Graphics processing units (GPUs) are sometimes used to help perform these or other functions. There remain, however, a number of limitations associated with conventional media playback.

### BRIEF DESCRIPTION OF THE DRAWINGS

FIG. 1 illustrates a block diagram of a smart encoding and decoding technique using tagging-data (TD), in accordance with an embodiment of the present invention.

FIG. 2a illustrates a TD-enabled encoder configured to generate encoded media with embedded tagging-data, in accordance with an embodiment of the present invention.

FIG. 2b illustrates a TD-enabled encoder configured to generate tagging-data as a supplementary stream in accordance with an embodiment of the present invention.

FIGS. 3a and 3b illustrate a match estimation process and a TD generation process, respectively, of a smart encoding technique, in accordance with an embodiment of the present invention.

FIG. 4a graphically illustrates a smart encoding process at a frame level, in accordance with an embodiment of the present invention.

FIG. 4b graphically illustrates a smart encoding process at a frame macroblock level, in accordance with an embodiment of the present invention.

FIG. 5a illustrates a TD-enabled decoder configured to provide smart media playback using embedded tagging-data, in accordance with an embodiment of the present invention.

FIG. 5b illustrates a TD-enabled decoder configured to provide smart media playback using a supplementary stream of tagging-data, in accordance with an embodiment of the present invention.

FIG. 6 illustrates a smart decoding technique, in accordance with an embodiment of the present invention.

FIGS. 7a-7d illustrate example screen shots that may provide an interface for selecting one or more smart playback options, in accordance with an embodiment of the present invention.

FIG. 8 illustrates an example system that may carry out a smart encoding technique and/or a smart decoding technique as described herein, in accordance with some embodiments.

FIG. 9 illustrates a mobile computing system configured in accordance with an embodiment of the present invention.

### DETAILED DESCRIPTION

Techniques are disclosed for content-sensitive tagging of media streams and smart media playback using generated tagging-data (TD). Tagging-data (e.g., tag index and location information for each content-sensitive tag) may be generated using a smart encoding technique that may be performed by a TD-enabled encoder. In some embodiments, the smart encoding technique may be implemented, for example, as a mechanism to generate tagging-data as part of a motion-estimation engine in a graphics processing unit (GPU). Generated tagging-data may be parsed using a smart decoding technique that may be performed by a TD-enabled decoder to provide a smart media playback experience based on the content-sensitive tags. Thus, for example, a video player application can use the tagging-data to achieve a smart-video-playback experience including a content sensitive search and selective playback options. In some instances, the smart encoding and/or smart decoding techniques may be performed by a GPU.

General Overview

As previously explained, there are limitations associated with conventional media playback experience. For example, GPUs currently use motion-estimation and motion-compensation algorithms to improve compression efficiency when encoding video data streams. However, GPUs and media encoding processes in general do not currently support content-sensitive tagging. As a result, conventional video playback does not support content sensitive search; rather, it simply supports sequential search of forward, reverse, or otherwise typical playback operations.

Thus, and in accordance with one or more embodiments of the present invention, tagging techniques are provided for a smart media playback experience. In some embodiments, tagging techniques are provided to identify whether and/or where reference data is located in various media for identifying one or more tags. The references (i.e., reference data) used for tagging may be, for example, images, video or audio clips, or text strings. Tags may be, for example, people or objects, catch phrases, rating information (e.g., R rated, PG-13 rated), themes (e.g., family theme, beach theme), or recognizable motions (e.g., basketball dunks, hand waves). The tags may each be identified by an index value and one or more references may be used to locate each individual tag. For example, two images (the references) may be used to locate one person (the tag). Location information may be taken, for example, at a frame level, at a frame macroblock level, at a media sequence level, or at a whole media level. The term “tagging-data” or “TD” as used herein includes the tag index and location information for each tag. The tagging techniques disclosed herein may be performed on any type of electronic or digital media stream (such as a video or audio recording) using a smart encoding technique as will be further appreciated in light of this disclosure.

For example, the tagging or smart encoding techniques may be used on a basketball game video (the media) to identify which frames (the locations) the starting players (the tags) are in, using images related to each player (the reference data). More specifically, the reference data may consist of images of the players' faces, for example. As will be further appreciated in light of this disclosure, various estimation technologies may be used to locate the reference data in the sports video for each individual player. In this example, face recognition technology may be used to estimate whether and/or where the players' face images are located in the sports video on a frame-by-frame basis to identify frame locations for the starting players. In some embodiments, the location information may be identified based on timing, such as elapsed time or sequential time. The aggregate of all the starting players' frame locations is the tagging-data, where each starting player (each tag) is identified by a tag index.

To further illustrate the tagging technique in this example case, the tagging-data may be output for the first quarter of the basketball game as shown in Table 1.

TABLE 1
Tagging-Data Example

| | Tag Locations | |
|---|---|---|
| | (starting frame- | Elapsed Time |
| Tag Index | ending frame) | (Seconds) |
| 1 | 1-7200, | 00:00:00 --> 00:04:00, |
| | 18000-21600 | 00:10:00 --> 00:12:00 |
| 2 | 1-14400 | 00:00:00 --> 00:08:00 |
| 3 | 1-21600 | 00:00:00 --> 00:12:00 |
| 4 | 1-14400 | 00:00:00 --> 00:08:00 |
| 5 | 1-21600 | 00:00:00 --> 00:12:00 |
| 6 | 1-21600 | 00:00:00 --> 00:12:00 |
| 7 | 1-10800 | 00:00:00 --> 00:06:00 |
| 8 | 1-21600 | 00:00:00 --> 00:12:00 |
| 9 | 1-14400 | 00:00:00 --> 00:08:00 |
| 10 | 1-21600 | 00:00:00 --> 00:12:00 |

In this example case, each starting player (tag) is associated with a tag index, and the corresponding tag index identifies the location of that player within the given video frames. As will be appreciated, a relatively large number of frames (in the thousands) equates to minutes of play. For instance, at 30 frames per second (FPS), 2 minutes of play equates to about 3600 video frames. In this example case, it is assumed that the basketball video shows all players who are playing at all times and the first quarter clock is a continuous 12 minutes with no breaks in the gameplay. For illustrative purposes, the tagging-data is displayed in Table 1 with a header row (row 1) and thicker lines are used to separate the header row, the starting players from team 1 (tag index 1-5), and the starting players from team 2 (tag index 6-10). For further illustrative purposes, the location information is included in two forms—frame locations and elapsed time. In other example scenarios, such as close-up shots under the boards, the number of players in those particular frames associated with the close-up may be reduced. As will be apparent in light of this disclosure, the elapsed time may be derived from the frame location information. As will also be apparent, the information in Table 1 may be output in a different format, such as a vector format. For example, for starting player 2, the tagging-data in vector form may be (2; 1-14,400). Further details of this example will be discussed in turn with reference to Table 2.

In another embodiment of the present invention, smart media playback techniques can use tagging-data to increase functionality and provide smart playback options based on the one or more tags. In some instances, the smart playback may allow adjusted playback based on one or more tags. In some other instances, the smart playback may allow the user to search or scan through the media based on one or more tags. The smart media playback techniques disclosed herein may be performed on any type of electronic or digital media that has accompanying tagging-data using a smart decoding process as will be further appreciated in light of this disclosure.

For example, the tagging-data from the basketball game example video above may be used to provide a smart playback experience. In this example, knowing which frames (the locations) the starting players (the tags) are located in allows for decoding and/or playback to be adjusted according to one or more of the starting players. If an end user selected to watch playback based on tag index 1 (i.e., starting player 1), then only frames 1-7200 and 18000-21600 would be shown (which translates to only the first four minutes and last two minutes of the first quarter, assuming 30 FPS). The end user may also be able to search or scan on a frame-block by frame-block basis, for example, to determine at what point in the first quarter starting player 1 enters and/or leaves the game. In this particular searching or scanning example, knowing the first and last frame of the frame blocks for starting player 1 (as shown in Table 1), the smart media playback may allow the user to scan between the following frames: frame 1 (start of the first quarter), frame 7200 (starting player 1 goes to the bench), frame 18000 (starting player 1 re-enters the game), and frame 21600 (end of the first quarter). Numerous variations and configurations will be apparent in light of this disclosure.

Smart Encoding and Decoding

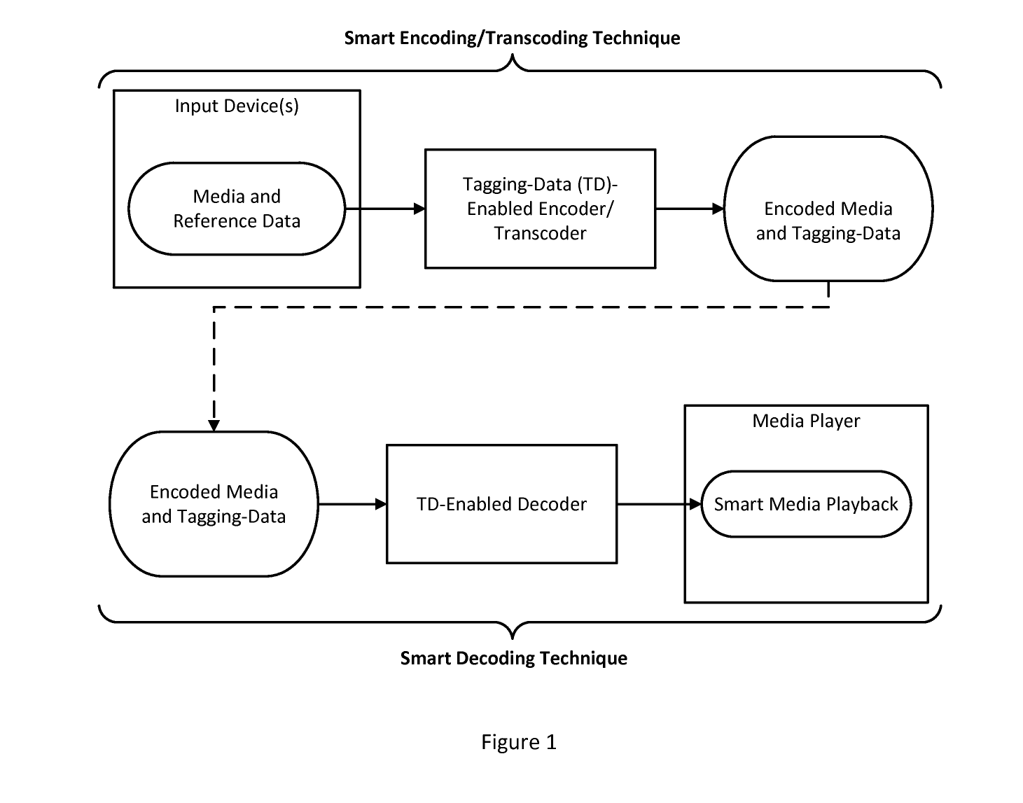

FIG. 1 illustrates a block diagram of a smart encoding and decoding technique, in accordance with an embodiment of the present invention. As previously described, the tagging or smart encoding techniques generate tagging-data while encoding the media, whereas the smart decoding techniques use generated tagging-data associated with an encoded media stream for smart media playback. As shown in FIG. 1, the smart encoding technique generally starts with media and reference data. A TD-enabled encoder receives the media and reference data from one or more input devices. The input device(s) may be any implementation of hardware and/or software, such as a computer, used to receive the media and reference data and to provide such media and reference data to the TD-enabled encoder. In some instances, the input device(s) may include the devices that record the media, such as a video camera or an audio recorder. The media may come in different formats; for example it may start on a physical object, such as a DVD, or it may start as a container format, such as an MPEG-4 file.

If the media comes in a compressed format, the media can be decoded to an intermediate raw or uncompressed format (such as PCM for audio or YUV for video) to allow the TD-enabled encoder to perform the smart encoding techniques disclosed herein. In some embodiments, the initial decoding may be performed by the input device(s), while in other embodiments, a TD-enabled transcoder may be used to decode the compressed media into a raw media format before performing the smart encoding techniques described herein. Therefore, whenever reference is made herein to a TD-enabled encoder or a smart encoding technique/process, it is intended to include a TD-enabled transcoder and a smart transcoding technique/process. After the smart encoding techniques are performed, the TD-enabled encoder outputs the encoded media and associated tagging-data for smart media playback use as described herein. The output of the TD-enabled encoder may be stored, for example, back to a suitable storage medium that is readable by a media player application, such as a DVD or video file, or may be streamed to a the TD-enabled decoder that can selectively display the content in accordance with a user's tag selection(s) as will be appreciated in light of this disclosure.

As further shown in FIG. 1, the smart decoding technique generally starts with encoded media and associated tagging-data that is received by a TD-enabled decoder. The TD-enabled decoder reads the tagging-data to provide smart media playback as requested by an end user. The smart media playback may be output to a media player to allow a user to view and/or hear the smart media playback. For example, the media player may include speakers when dealing with smart audio playback or the media player may include a display when dealing with smart video playback.

The dotted line in FIG. 1 indicates that the smart encoding and decoding techniques may be performed separately in some embodiments, while in other embodiments, the smart encoding and decoding techniques may be capable of being performed by the same software and/or hardware, such as by a single GPU and/or other suitable processor. In other words, in some embodiments, the techniques that generate tagging-data may be performed separate from the smart media playback techniques that use the generated tagging-data, while in other embodiments, the tagging-data generation techniques and smart media playback may be performed by the same software, hardware, and/or firmware, such as by a single computer system.

As will be appreciated in light of this disclosure, the various functional modules and the smart encoding and decoding techniques described herein can be implemented, for example, in any suitable programming language (e.g., C, C++, objective C, custom or proprietary instruction sets, etc.), and encoded on one or more machine readable mediums, that when executed by one or more processors, carry out the smart encoding and/or decoding techniques as described herein. Other embodiments can be implemented, for instance, with gate-level logic or an application specific integrated circuit (ASIC) or chip set or other such purpose built logic, or a microcontroller having input/output capability (e.g., inputs for receiving user inputs and outputs for directing other components) and a number of embedded routines for carrying out graphics workload processing, including tagging-data generation and use as variously described herein. In short, the various functional modules can be implemented in hardware, software, firmware, or a combination thereof.

TD-Enabled Encoder and Smart Encoding

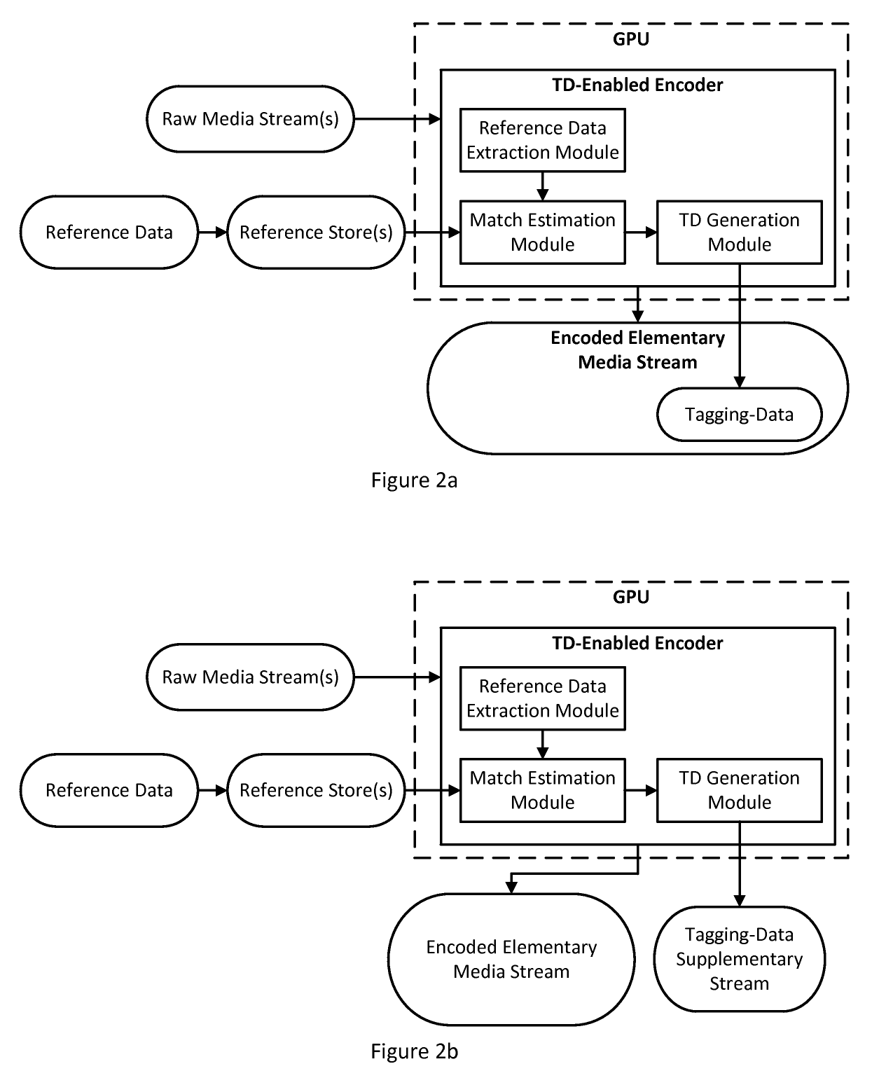

FIG. 2a illustrates a TD-enabled encoder configured to generate encoded media with embedded tagging-data, in accordance with an embodiment of the present invention. As previously described, the TD-enabled encoder receives one or more raw media streams to generate tagging-data output. Generally, the TD-enabled encoder uses a match estimation module to identify whether and/or where the reference data is located in the raw media stream(s). If a match is found, the tag index and tag location information are output to a TD generation module. In this embodiment, the TD generation module formats all of the location information for each tag and embeds the tagging-data into the encoded elementary media stream. FIG. 2b illustrates a TD-enabled encoder configured to generate tagging-data as a supplementary stream in accordance with an embodiment of the present invention. In some embodiments, the process of embedding additional information in an encoded media stream (as is the case in the embodiment in FIG. 2a) or providing a supplementary stream of additional information to an encoded media stream (as is the case in the embodiment in FIG. 2b), can be carried out, for example, in a similar fashion as is done with subtitling or captioning. In some other embodiments, the supplementary steam can be encoded using entropy encoding algorithms. As disclosed herein, a TD-enabled decoder may parse the embedded tagging-data or the tagging-data supplementary stream to access information about the tags and provide one or more smart media playback options.

Reference data may come in the form of, for example, an image (such as a YUV static image file), a video or audio clip, or a text string. In some applications, the reference data may be individually indexed to facilitate management of the references or to provide reference data information for a corresponding tag. In some instances, the reference data may be external to the raw media stream(s). In other instance, the reference data may be extracted from one or more of the raw media streams, such as through the use of a reference data extraction module as described herein. The reference data may be organized into one or more reference stores to more easily manage the individual references. Reference data and reference stores may be pre-made and/or user-created.

For example, continuing with the previous basketball game video, the reference data may be chosen from a pre-made reference store, user-created references, or extracted references. In this example, a pre-made reference store for each particular basketball team may contain the following reference data: 1) static images of the players' faces, jerseys, and bodies; 2) video clips of the players' signature moves; and/or 3) audio clips of the players' voices. The user interface for the smart encoding process may be configured to allow the user to automatically select all of the reference data in the pre-made reference store, only the desired references from the reference store, or reference data, for example, on a per-tag (i.e., a per-player) basis. The user interface of the TD-enabled encoder may be configured to allow the user to select user-created references or extracted references, as described herein.

In some embodiments, a TD-enabled encoder may include a reference data extraction module. The reference data extraction module may allow a user to select reference data from one or more media streams to identify other locations where the extracted reference data is located in the same or other media streams. In some instances, a TD-enabled encoder may be configured to only use the references extracted using the extraction module, in other words, no additional references are provided for use in the tagging process other than those extracted from the media stream. The extraction module can be configured (e.g., through a user interface) to extract based on one or more particular interests, such as faces, cars, buildings, similar scenery (e.g., beach scenes), etc. Once the one or more particular interests are selected, the extraction module can extract all instances For example, continuing with the previous basketball game video, the reference data extraction module may be configured to extract any faces in the video and assign a reference data index to it for use in the tagging process.

A match estimation module can receive the one or more media streams and the reference data to identify whether and/or where the reference data is located in the media stream(s). To determine matches, the match estimation module may use one or more known estimation technologies, such as motion-estimation engines (e.g., motion-estimation engines found in Intel® GPUs), face recognition algorithms (e.g., principal component analysis), and/or speech recognition software (e.g., Dragon® voice recognition software). The match estimation module may use one or more references per tag to determine tag location information. Accordingly, the match estimation module may use one or more estimation technologies per tag to determine tag location information.

For example, continuing with the previous basketball game video, the match estimation module may use the following estimation technologies and respective reference data to identify whether and/or where the reference data is located in the raw media stream(s): 1) face recognition algorithms for the images of the players' faces; 2) motion-estimation engines for images of the players' jerseys and bodies and video clips of the player's signature moves; and/or 3) speech or audio recognition software for the audio clips of the players' voices. Therefore, to determine the location for one starting player (i.e., one tag), the match estimation module may use any combination of reference data and estimation technologies, such as one face image/one face recognition algorithm, face images/one face recognition algorithm, one face image/face recognition algorithms and jersey images/one motion-estimation engine, audio clips of the player's voice/audio recognition software and multiple face images/multiple face recognition algorithms, etc.

The TD generation module may then receive the tag index and corresponding location information from the match estimation module. In some instances, the TD generation module may receive additional tag information for each tag index in addition to the corresponding location information, such as the media category, media name/ID, tag category, type tag name/ID, tag date, number of references used, types of reference data used, estimation technologies used, processing time, or other various information. The additional tag information may be input to the TD generation module from different sources, such as from the match estimation module, the user interface, or a reference store. For example, a pre-made reference store may group reference data by tag index and the TD generation module may be configured to receive additional tag information (such as tag category and tag name) from the reference store so that it can assign this information to each tag index when generating the tagging-data. In some instances, the TD generation module may receive name/ID information from the raw media stream to identify the media that the tagging-data is associated with as described herein (especially in embodiments where the tagging-data is generated as a supplementary stream, such as in FIG. 2b). In some cases, the additional information related to each tag (i.e., related to each tag index) may be provided during the smart decoding process and/or during smart playback.

For example, continuing with the previous basketball game video, the pre-made reference store described above may have additional information for tag index 1 (i.e., starting player 1), such as the tag category (person), tag specific category (basketball starting player), tag name/ID, tag team, tag position, etc. To further illustrate this example embodiment, the tagging-data may be output for the first quarter of the basketball game with additional tag information as shown in Table 2.

TABLE 2
Tagging-Data with Additional Tag Information

| Tag | Tag Locations | | | Tag |
|---|---|---|---|---|
| Index | (Frames) | Tag Name/ID | Tag Team | Position |
| 1 | 1-7200, | Mario Chalmers | Miami Heat | PG |
| | 18000-21600 | | | |
| 2 | 1-14400 | Dwayne Wade | Miami Heat | SG |
| 3 | 1-21600 | LeBron James | Miami Heat | SF |
| 4 | 1-14400 | Shane Battier | Miami Heat | PF |
| 5 | 1-21600 | Chris Bosh | Miami Heat | C |
| 6 | 1-21600 | Raymond Felton | N.Y. Knicks | PG |
| 7 | 1-10800 | Iman Shumpert | N.Y. Knicks | SG |
| 8 | 1-21600 | Carmelo Anthony | N.Y. Knicks | SF |
| 9 | 1-14400 | Amar'e Stoudemire | N.Y. Knicks | PF |
| 10 | 1-21600 | Tyson Chandler | N.Y. Knicks | C |

In some instances, the TD generation module may receive information about the media stream(s) to perform one or more conversions on the received tag information. For example, as the media stream(s) are encoded, the location information (such as the frame information) may be converted to time information for each tag (e.g., as shown in Table 1). The conversions may help facilitate the smart decoding process and smart media playback disclosed herein. Reference data may also accompany the tagging-data to visually or aurally identify the tag(s). For example, a reference image may accompany each tag index to visually identify the tag during smart media playback. The TD generation module formats all of the tag index information, corresponding location information, and optional additional information and outputs it as tagging-data. The tagging-data may be organized and output in various different formats, such as a vector format (e.g., (tag index 1; tag 1 locations), (tag index 2; tag 2 locations), . . . (tag index n; tag n locations)), a table format (e.g., Tables 1 and 2), or any other format that allows the tagging-data to be parsed by a TD-enabled decoder using the smart decoding technique described herein.

In some instances, the TD-enabled encoder may be capable of automatically generating tagging-data using the match estimation module and reference data extraction module to automatically identify and extract one or more references to be matched within the media. For example, the TD-enabled encoder may be configured to use a face recognition algorithm to identify images of people's faces within a video, extract out the face images for use as reference data, and then automatically locate other instances of the extracted face images in that video or other videos to identify tags (i.e., the people). In some embodiments, the TD-enabled encoder may allow a user to input additional information for the automatically generated tagging-data (such as the tag name/ID). In some other embodiments, the TD-enabled decoder may be connected to a database (either locally or through a cloud server) to retrieve additional information for the automatically generated tagging-data. Therefore, in embodiments where the TD-enabled encoder can automatically generate tagging-data, the TD-enabled encoder may only be required to receive the raw media streams, since the reference data can be extracted from the media streams themselves.

In some embodiments, and as indicated by the dotted line in FIGS. 2a-2b, the TD-enabled encoder may be contained entirely within a GPU. In other words, a GPU may be programmed or otherwise configured to perform all of the functions of the TD-enabled encoder, which may improve smart encoding performance, speed, and/or power consumption (just as GPUs improve other encoding techniques through what is referred to as hardware acceleration, for example). In other embodiments, the TD-enabled encoder may be executed in part by the GPU and part in the CPU. In a more general sense, the TD-enabled encoder may be implemented in any suitable processing environment that can carry out the various smart encoding functionalities described herein.

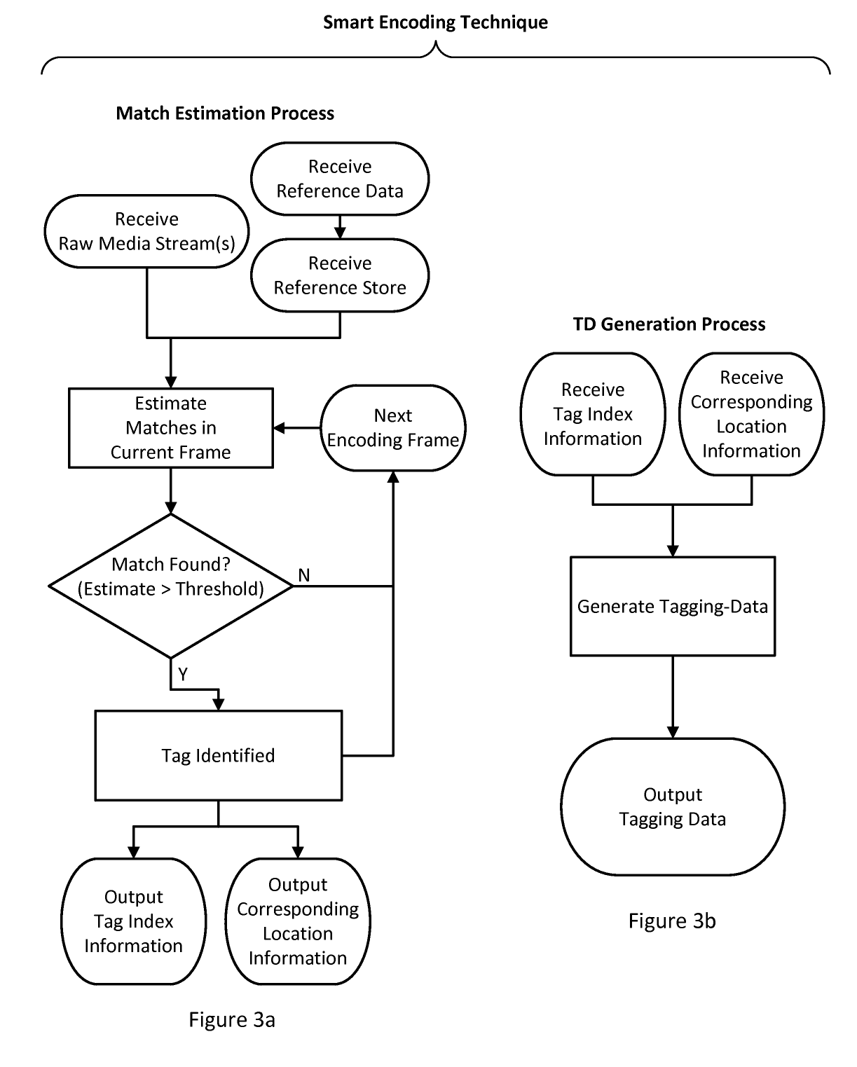

FIGS. 3a and 3b illustrate a match estimation process and a TD generation process, respectively, of a smart encoding technique, in accordance with an embodiment of the present invention. As shown in FIG. 3a, the match estimation process starts by receiving one or more raw media streams and reference data. The reference data may first be organized into a reference store as previously described, in which case the reference store is received. In this example embodiment, the tags are identified on a frame-by-frame basis. Therefore, after receiving the raw media stream(s) and reference data, matches are estimated to identify whether one or more tags are located in the current frame of the raw media stream(s). If the match is found and the tag is identified in that frame, then the tag index and the corresponding location information (in this case, the frame location) are output for the TD generation process. This is performed on each frame until completion. The match estimation may be performed a tag at a time or simultaneously for all tags within each frame, depending upon the configuration of the smart encoding process.

A threshold value may be used to determine if the tag is present in the frame. For example, continuing with the basketball game video, if two pieces of reference data (and corresponding estimation technologies) are being used to identify tag index 1 (i.e., starting player 1), such as a face image using a face recognition algorithm and a jersey image using a motion estimation engine, then the threshold may be set such that the maximum of those two estimation processes exceeds a certain value, such as 95%. For instance, if only the player's face is available in a certain video frame, then the face recognition algorithm may produce a match of 99%, while the motion estimation engine may produce a match of 0%. The maximum of these two estimation values (99%) is greater than the threshold (95%), therefore starting player 1 is present in that frame. In other words, the tag is identified. Numerous other thresholding and matching schemes can be used to identify tags, and thus, the provided example is not meant to limit the claimed invention.

As shown in the example embodiment of FIG. 3b, the TD generation process receives the tag index and corresponding tag location information to generate and output the tagging-data as disclosed herein. As previously described, the tagging-data may be embedded into the encoded elementary media stream (see FIG. 2a) or provided as a tagging-data supplementary stream (see FIG. 2b). In some instances, it may be useful to know that a reference or tag has not been identified within a media stream, since this information may indicate, for example: 1) that the reference or tag is not present within the media stream; 2) that the TD-enabled encoder may need to be configured differently to be able to locate the reference or tag (e.g., the threshold value may need to be lowered where the user knows that the reference or tag is located in the media); or 3) that different or better reference data may need to be used to locate the tags (e.g., indicating that the reference data is too distorted).

The tag location information identified by the match estimation module and output by the TD generation module may range from, for example, very broad location information (such as whether the tag is even present in a video) to very specific location information (such as the macroblock location in each frame of a video where a tag is identified). Accordingly, the location information may be identified at the whole media level, media sequence level, frame level, macroblock level, etc. As will be apparent in light of this disclosure, the precision of the tag location information may depend upon the application or use of the tagging-data. For example, the TD-enabled encoder may be configured to estimate broad location information if the user wants to know whether a tag is even present in one or more pieces of media. This may be used, for example, to search multiple home videos to determine whether a family member is present in the video. Alternatively, specific location information may be desired in some applications, such as when searching for objects within a video.

Just as tagging-data can be located at different levels, the generated tagging-data can also be associated with the media at different levels. For example, one frame worth of data when dealing with video bit streams is called an access unit (i.e., access unit=one frame worth of data=frame itself+any other supplementary stream associated to the frame, such as captioning). Tagging-data can be included in each access unit as a part of the supplementary stream of information associated with the frame. In other words, tagging-data which is associated with a particular frame will be a part of the access unit payload for that particular frame. Accordingly, tagging-data may be associated with media sequences in the same manner. For example, video sequences can be identified by new video sequence headers in the video bit stream based on tagging-data. In these cases, the tagging-data can include an indication that the tagging-data applies to the whole video sequence (i.e., until the next video sequence is reached) or the TD-enabled decoder, discussed herein, may intelligently. Therefore, tagging-data may include an indication of the level of association (e.g., frame level, media sequence level, entire media level, etc.) to facilitate the smart decoding and smart media playback techniques described herein.

Further, the generated tagging-data may determine at what media level the tagging-data is used during the smart decoding and smart media playback techniques described herein. For example, the tagging-data generated in Table 1 shows that each tag is in a large number of frames; therefore, the most appropriate level for the smart decoding process and/or smart video playback in this example may be at a video sequence level. This may make the decoding process more efficient while providing a smart playback experience, since it may, for example, avoid sending the tagging-data for every access unit (i.e., for every frame). To further illustrate this example, if the tagging-data in Table 1 was generated as a tagging-data supplementary stream, the supplementary stream can be associated to the basketball game video sequence header to facilitate the smart decoding techniques. As will be apparent in light of this disclosure, a tagging-data (TD)-enabled decoder can then use the video sequence header (with associated tagging-data) to decide which frames should even be decoded (in other words, which frames can be skipped when decoding). Continuing with the previous basketball game video example, using starting player 1 (i.e., tag index 1), the tagging-data shows that starting player 1 is only in frames 1-7200 and 18000-21600. Accordingly, this information can be used by a TD-enabled decoder to skip frames 7201-17999 during the decoding process of smart video playback following just starting player 1. Therefore, in some instances, the association level of the tagging-data may increase the efficiency of the smart decoding and smart playback techniques.

In cases where tagging-data is associated at the whole media level, the tagging-data may be generated to allow the TD-enabled decoder to determine the media containing the desired tag(s), such as through an indexing system. For example, if tagging-data were generated at the whole media level to determine which home movies contain a certain grandparent (e.g., tag index 1 is the grandparent and the location information is at the whole media level), and a user desired to watch only the home videos that contain that grandparent then the smart decoding process may simply read the tagging-data (in this case, the index system) to know which videos to play and which videos to skip. If the tagging-data also contained more precise location information (e.g., the frame locations for the grandparent), then the smart decoding process may facilitate quickly finding the frames or video sequences containing that grandparent, but it would only get to this second location level in the home videos it did not skip at the whole video level. In this case, the association level (whole media) increases the efficiency of the smart decoding and smart playback techniques since whole videos can be skipped, saving performance, power, and time.

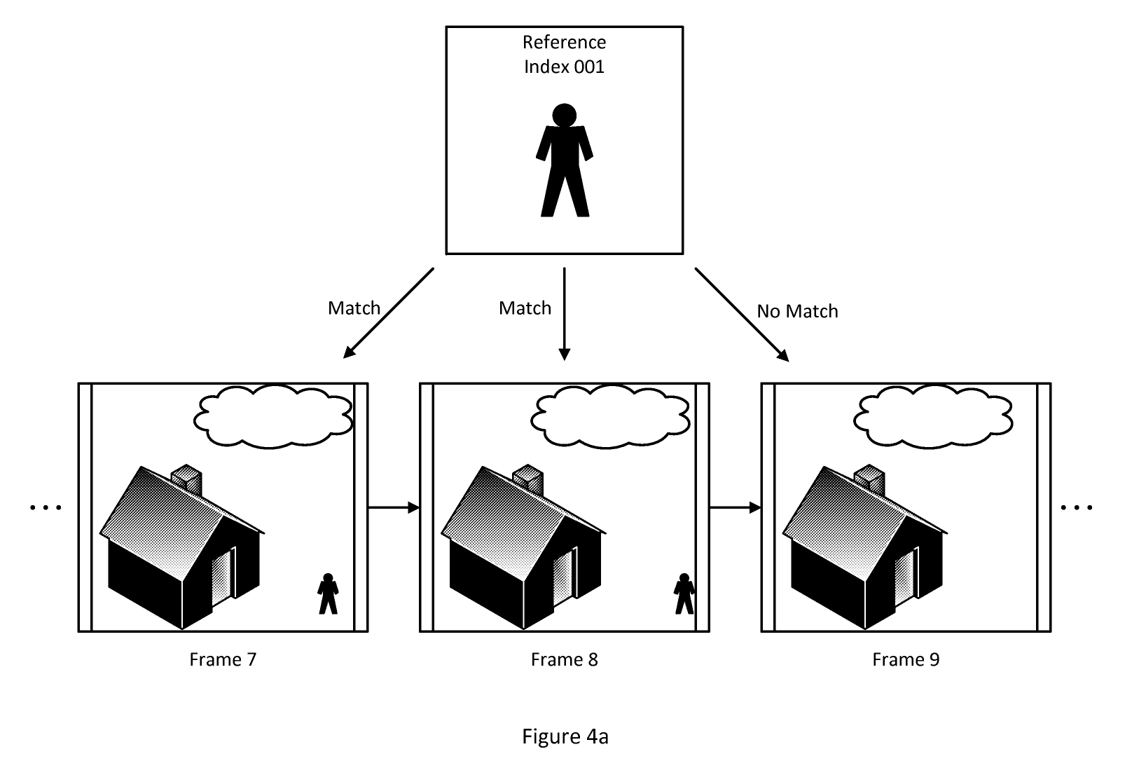

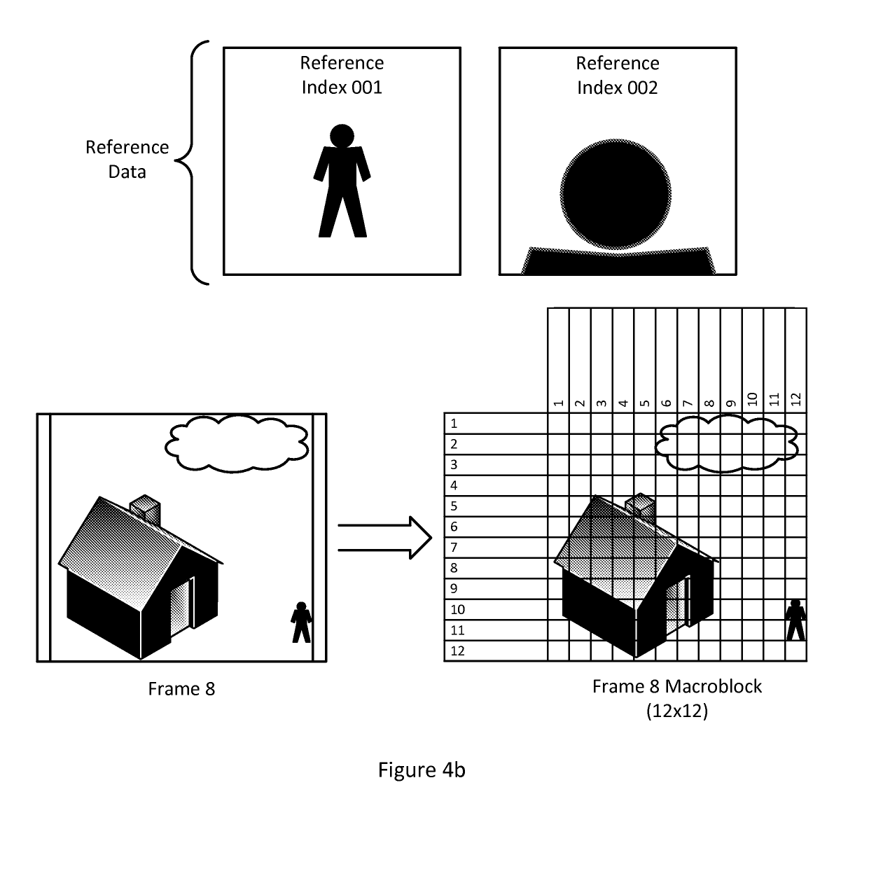

FIG. 4a graphically illustrates a smart encoding process at a frame level, in accordance with an embodiment of the present invention. As previously described, reference data may be indexed for identification purposes. In this embodiment, only one piece of reference data, reference index 001 (an image of a person), is being used to identify the only desired tag, tag index 01 (a person). Using techniques described herein, the TD-enabled encoder in this embodiment can identify whether reference index 001 is located in each frame to identify tag location information for tag index 01. In other words, the smart encoding process identifies in which frames the person is located. As shown, matches for reference index 001 are identified in frames 7 and 8. If these are the only frames the man is located in, the tagging-data associated with this embodiment as generated in, for example, vector format, can be output as: (01; 7-8).

FIG. 4b graphically illustrates a smart encoding process at a frame macroblock level, in accordance with an embodiment of the present invention. In this embodiment, frame 8 from FIG. 4a was partitioned into a 12×12 macroblock to obtain a more precise tag location for tag index 1 (the person). A 12×12 macroblock partitioned is used in this example for ease of description; however, in other embodiments, the TD-enabled encoder and smart encoding process may be configured to partition frames into any amount or size of macroblocks to provide more or less precise location information. For example, high-definition (HD) video is generally encoded at a resolution of at least 1280×720p and HD video at that resolution is generally partitioned into an 80×40 size when macroblocking is performed.

In the example embodiment shown in FIG. 4b, two pieces of reference data, reference index 001 (the image of the person) and 002 (an image of the person's face), are being used to identify tag index 01. As previously described, the additional reference may be used to, for example, increase the likelihood of locating the tag in the media. The macroblock location of the tag (the person) may be generated, for example, in a format that indicates the macroblock rectangle the tag is located in from one corner to the other, such as its top-left corner to its bottom-right corner. For example, the cloud as shown in the 12×12 macroblock of frame 8 is located from 1:6-3:12 (column:row) using a rectangular location information. In some instances, the macroblock locations for the tags may be indicated as one corner of the macroblock, such as the top left corner. For example, the cloud as shown in the 12×12 macroblock of frame 8 is located at 1:6 using single corner location information (in this case, the top-left corner).

Additional information, such as the media type (video), media name/ID (Casablanca), tag category (person), tag name/ID (Humphrey Bogart), reference data used to identify the tag (references 001-002), and the tag location precision level (frame macroblock) may be included in the tagging-data as previously described. For illustrative purposes, the tagging-data associated with the frame in this embodiment as generated in, for example, vector format, can be output as: (01; 8; 10:12-11:12; video; Casablanca; person; Humphrey Bogart; 001-002; frame macroblock), (02; 8; 1:6-3:12; video; Casablanca; object; cloud; 003-015; frame macroblock), etc.

The macroblock location information may be used, for example, to facilitate searching or scanning for tags within encoded media streams, as described herein. For instance, the macroblock location information may be used to place a rectangular box around the tags, based on the macroblock information. If searching/scanning for multiple tags at once (e.g., if tagging-data was available for every car in a video) and multiple tags are in the same frame, then each rectangular tag box may include, for example, the corresponding tag name to further identify each tag. The examples illustrated and described herein are not meant to limit the claimed invention.

In some embodiments, a user may manually generate tagging-data and/or manually review and correct the tagging-data generated by a smart encoding process. The manual generation of tagging-data may be performed by a user that manually locates tags to generate tagging-data. Manual generation of tagging-data may be useful for some smart media playback applications, especially where it may be challenging to use available estimation technologies to generate tagging-data. For example, if a video content creator wanted to provide smart playback based on rating information (e.g., G rating, PG rating, etc.), it may be difficult to accurately generate tagging-data related to rating information using the smart encoding techniques described herein. In these instances, a user (such as the content creator) may manually generate the tagging-data related to rating information to allow for smart video playback based on the selected rating. In some other instances, a user may manually review the tagging-data generated by a TD-enabled encoder to correct and/or supplement the results produced by the smart encoding process.

In some embodiments, the TD-enabled encoder and/or decoder may be configured for automatic or manual methods of recognizing and correcting for gaps in tagging-data location information. For example, continuing with the basketball game video, if starting player 1 (i.e., tag index 1) were missing in some frame sections, such as 5000-5100, due to the camera selection switching to a close up of another player, then these gaps may be accounted for during the smart encoding process and/or the smart decoding process. For instance, the TD-enabled encoder may recognize the large frame sections before and after the gap from frames 5000-5100 (i.e., sections 1-5000 and 5101-7200) and connect them such that the gap is included in the tagging-data location information, resulting in the whole video sequence from frame 1 to frame 7200 being associated with tag index 1 (as is the case in Tables 1 and 2). In some cases, the TD-enabled encoder may not correct for gaps, and the tagging-data location information may instead be generated such that tag index 1 has frame location information of 1-5000, 5101-7200, and 18000-21600. In these cases, the TD-enabled decoder may correct for the gap by recognizing that a gap of only 100 frames is missing and therefore use the entire frame section or video sequence from 1-7200 if performing a smart decoding or smart playback technique based on starting player 1. Correcting for gaps may smooth out the smart media playback and enhance the overall experience.

When using gap correction during either smart decoding or smart encoding, the settings for correction may be configured automatically or configured by a user to determine the size of the gap that will be included. In the cases where the gap correction is performed during the smart encoding process, the size of the gaps that are corrected may be relative to the location information found for the tag. For example, continuing with the basketball game video, if there was a second gap from frames 20000-20500 (i.e., ˜16.7 seconds based on 30 FPS), then this gap may not be corrected for based on the gap correction settings. To further illustrate, if the gap correction settings were configured to correct for gaps of 150 frames (5 seconds) or less, then the gap from 5000-5100 would be corrected for, but the gap from 20000-20500 would not. As previously described, the 150 frame max gap size for correction may be selected automatically by the TD-enabled encoder/decoder (e.g., relative to the frame sections where the tag was located) or manually (e.g., by a user during smart encoding/decoding). The new tagging-data in this specific example for starting player 1, in vector format, would be: (1; 1-7200, 18000-19999, 20501-21600).

In some embodiments, the TD-enabled encoder may be configured to have different modes. The modes may be setup, for example, based on the desired tag location precision. For example, a search mode may be setup to locate tags at the macroblock level to facilitate a smart playback option that searches or scans for the tags in the media. In some instances, the different modes may be automatically selected based on, for example, the raw media stream or reference data being received (such as entering smart video encoding mode when a raw video stream is received). In some other instances, the different modes may be selected by the user based on the desired smart encoding process. For example, the user may select a whole media mode, whereby the TD-enabled encoder stops the match estimation process after one instance of the tag is located, thereby identifying that the tag is present in the media.

The quality, accuracy, processing requirements, and/or processing speed of the TD-enable encoder and the smart encoding process may be affected by various factors or settings. For example, the various factors or settings may include the different types of reference data used, the number of references being used per tag, the estimation technologies being used, the number of tags being identified, the different types of tagging-data, the precision of the tag location information, the number and nature of the user configurable options, and/or the specifications of the TD-enabled encoder. Accordingly, in some embodiments, one or more of the various settings (such as the tag location precision) may be configured by the user (e.g., through a user interface) to select the quality, accuracy, and/or precision of the smart encoding process, similar to the manner in which a user can configure various settings (such as frame rate, bitrate, audio quality, etc.) when encoding media without the tagging techniques disclosed herein.

Encoded media with embedded tagging-data or an associated tagging-data supplementary stream can still be decoded and played by non-TD-enabled decoders; however, if decoding is performed by a non-TD-enabled decoder, smart media playback using the tagging-data may not be available. In other words, the tagging-data does not prevent the encoded media from being played as is conventional, regardless of the decoder being used. In this manner, if a user is watching a video using a decoder that cannot decode the tagging-data and/or a media player that cannot use the tagging-data, then the video can still be played without using the smart media playback options described herein. Thus, so-called legacy playback remains unencumbered.

TD-Enabled Decoder and Smart Decoding

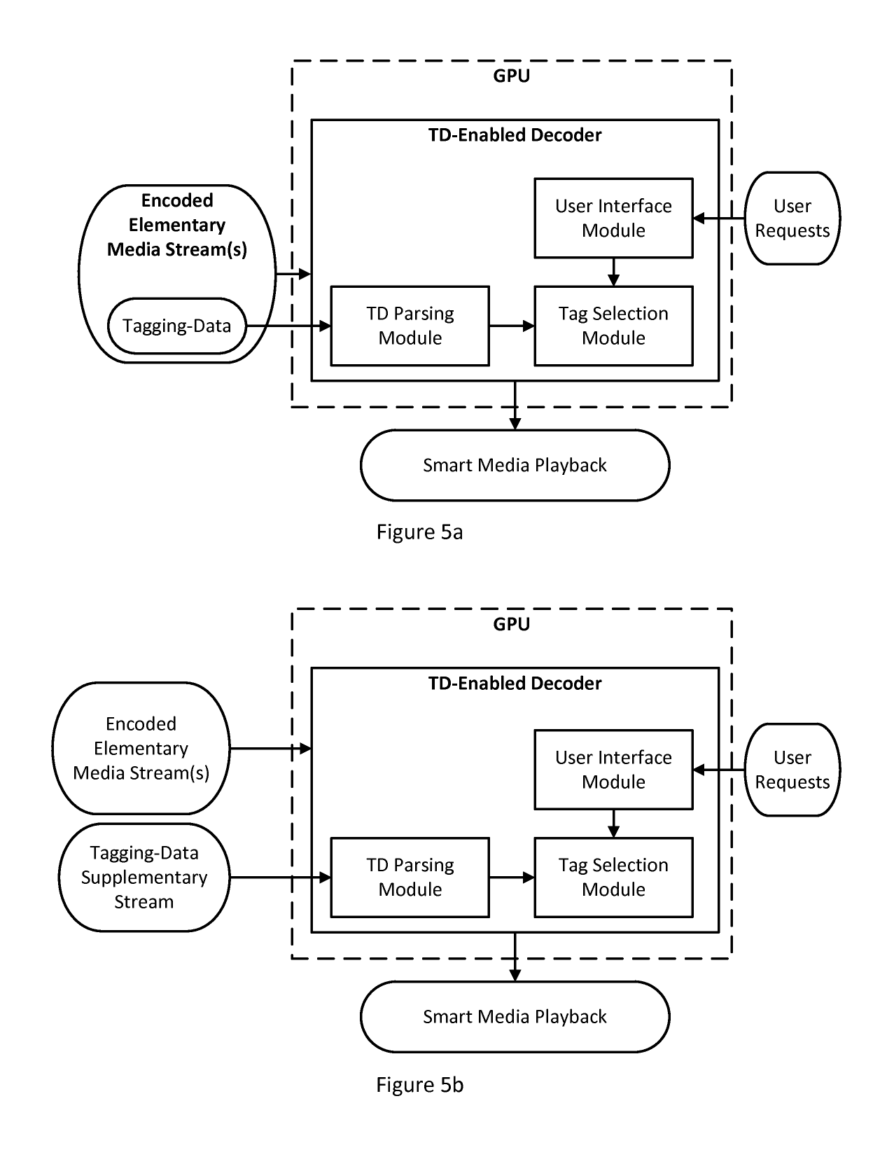

FIG. 5a illustrates a TD-enabled decoder configured to provide smart media playback using embedded tagging-data, in accordance with an embodiment of the present invention. As previously described, the TD-enabled decoder receives an encoded elementary media stream with associated tagging-data and user requests in order to provide smart media playback. Generally, the TD-enabled decoder may have a TD parsing module to parse the tagging-data associated with the media stream and a user interface module to read the user requests. The TD-enabled decoder may have a tag selection module to select and output the requested smart media option based on the parsed tagging-data and user requests. In FIG. 5a, the tagging-data is embedded in the encoded elementary media stream; therefore, it is understood that the tagging-data is associated with that particular encoded elementary media stream. In some instances, the available tag information in the tagging-data may be indicated, such as indicating that the embedded tagging-data includes tags for all of the main actors and actresses in the video (thereby allowing, for example, smart video playback of just the scenes including the selected actor or actress).

FIG. 5b illustrates a TD-enabled decoder configured to provide smart media playback using a supplementary stream of tagging-data, in accordance with an embodiment of the present invention. Since the tagging-data is encapsulated as a supplementary stream separate from the encoded elementary media stream in this embodiment, the tagging-data supplementary stream file may include identification information to indicate the media it is associated with and/or the tag information it includes. The associated media and tag information may be indicated, for example, in the name of the tagging-data supplementary stream file, in an introductory portion of the file, or in a separate text file included with the tagging-data file. For example, and continuing with the previous basketball game video, if a tagging-data supplementary stream file were generated for the entire basketball game between the Miami Heat and the N.Y. Knicks and the game occurred on Nov. 2, 2012, the tagging-data supplementary stream file may be named “NBA_Heat-Knicks_{—}11-2-12_starting-player-tags.td” to indicate the media with which it is associated.

In some embodiments, and as indicated by the dotted line in FIGS. 5a-5b, the TD-enabled decoder may be contained entirely within a GPU. In other words, a GPU may be programmed or otherwise configured to perform all of the functions of the TD-enabled decoder, which may improve smart decoding performance, speed, and/or power consumption (just as GPUs improve other decoding techniques through what is referred to as hardware acceleration). In other embodiments, the TD-enabled decoder may be executed in part by the GPU and part in the CPU. In a more general sense, the TD-enabled decoder may be implemented in any suitable processing environment that can carry out the various smart playback functionalities described herein.

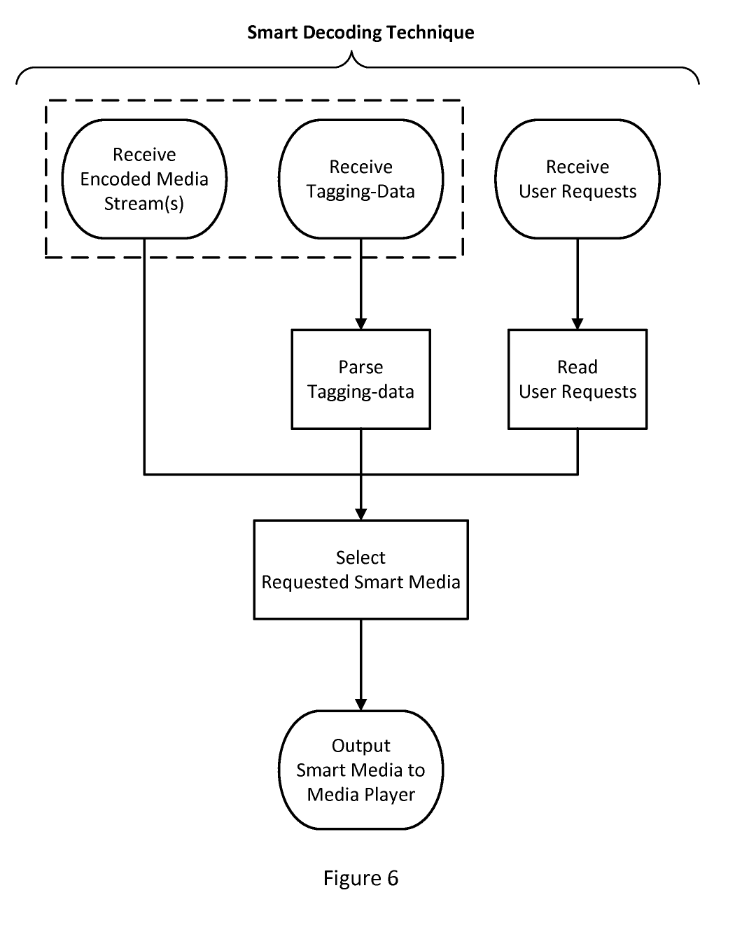

FIG. 6 illustrates a smart decoding technique, in accordance with an embodiment of the present invention. As shown, the smart decoding technique starts by receiving one or more encoded media streams and associated tagging-data. The dotted box drawn around the encoded media stream(s) and the tagging-data indicates that the tagging-data may be embedded in the encoded media stream(s) (or it may be provided as a supplementary stream as previously explained). The tagging-data is parsed to provide smart media playback options to a user. User requests are received and read to select a smart media playback option. After the requested smart media is selected, the media is output to a media player to be viewed, heard, etc. In some instances, playback of requested smart media may involve additional user requests. For example, where the tagging-data is being used to scan or search for a tag throughout the media, the smart decoding technique and/or smart media playback may be configured such that the user can select the next or previous tag location.

Smart Media Playback

The tagging-data and smart decoding techniques described herein may be used for numerous different smart playback options. In some embodiments, a smart media playback option may allow adjusted playback based on one or more tags. In some other embodiments, the smart media playback may allow a user to search or scan through the media based on one or more user-selected tags. In some instances, the available smart playback options may be dependent on the generated tagging-data being used. For example, a user may be constrained by the specific tags or tag location precision provided by the generated tagging-data. Therefore, the end application may be considered when generating tagging-data. Example smart media playback options are provided herein to illustrate some of the functionality gained from using generated tagging-data. As is apparent in light of this disclosure, the use of tagging-data and smart playback options allows a user to experience a single piece of media in numerous different customizable ways. These examples are not meant to limit the claimed invention.

As previously described, some smart playback options may allow playback based on one or more tags, such as playback of just the scenes including one or more selected actors/actresses in a movie or television show, one or more selected sports players in a sports game video, or one or more objects in a video. In a specific example application, a smart media playback option of the movie Casablanca may only playback the scenes that include Humphrey Bogart (in other words, the playback skips all of the scenes without Humphrey Bogart). In another specific example application, a smart media playback option may allow a user to view only the parts of a home-made video where his/her child or a grandparent is present in the video. In yet another specific example application, a smart media playback option may allow a user to follow his/her favorite race car in a video of an automobile race and skip the rest of the automobile race. In another specific example application, a smart media playback option may allow a user to only view scenes in the Terminator movie series where Arnold Schwarzenegger says the catch phrase “I'll be back.”

Some media playback options may allow a user to search and/or scan through the media based on one or more tags, such as searching/scanning for one or more selected people in a video, one or more phrases in an audio recording, or one or more objects in a video. In a specific example application, a user may search/scan, in a sequential manner, through the media to view where one or more tags are located. The search or scan may be performed, for example, on a media sequence, frame, or frame macroblock level. As previously mentioned, search/scan level may be dependent on the tag location precision of the tagging-data being used. For example, if the tagging-data includes frame location information for each tag, then a user may be able to search/scan through a video to view each frame that contains one or more selected tags. In a specific example application, a smart media playback option may allow a user to search/scan one or more videos for a specific building, such as the Empire State Building to identify scenes that occur in New York City. In another specific example application, a smart media playback option may allow a user to search/scan one or more audio recordings of speeches for instances of the word “like” to help the speaker correct bad habits.

Smart media playback may also include other options, such as playback based on theme or media rating. In example applications using themes, smart media playback options may allow a user to playback the media based on, for example, genre, mood, or location, such as mountain, restaurant, family, etc. In a specific example theme application, and keeping with the family theme, a smart media playback option may allow a user to playback only scenes of a home-made video that shows family, which may be triggered where two or more family member tags are present. Therefore, smart media playback applications may use more than one tag for a smart media playback option. In example applications using media rating, a content creator can provide manual tagging-data for the different media ratings, as described herein, to allow a user to playback the media based on the selected media rating.

The tagging-data may be used for various other applications, such as statistical analysis of media or cataloguing of multiple pieces of media. For example, cataloguing may be performed on a media set knowing the different tags that are present in each piece of media, which can be used to organize the media according to different tags. In a specific example cataloguing application, in a media set of home-videos, all videos (and, depending upon the tag location precision used when generating the tagging-data, every video sequence or frame) with a grandparent present could be quickly identified for use in making a birthday compilation video for the grandparent.

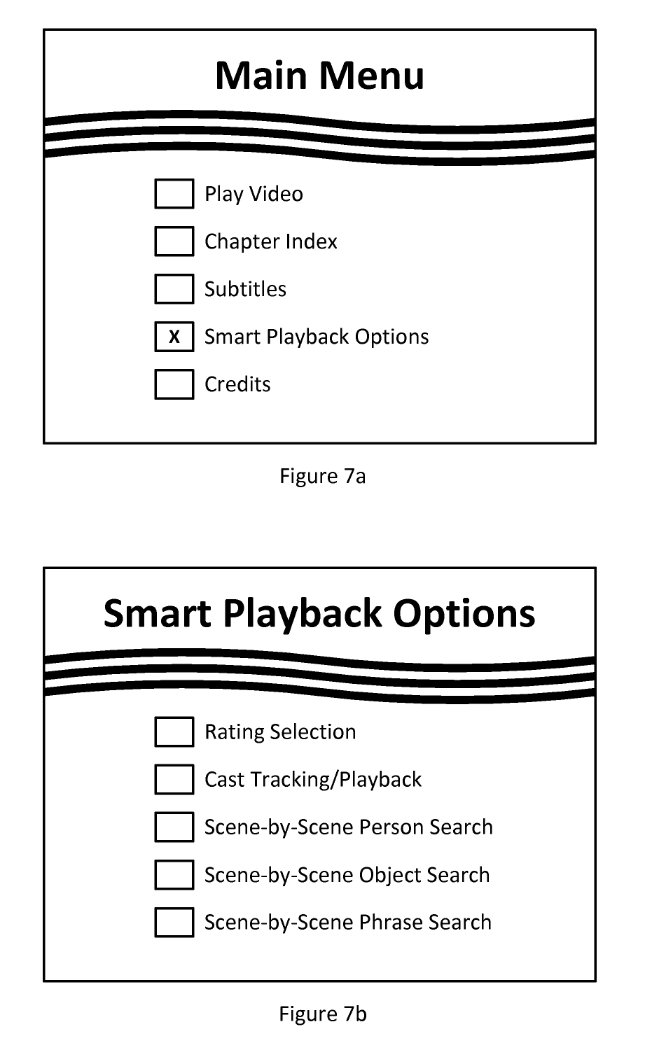

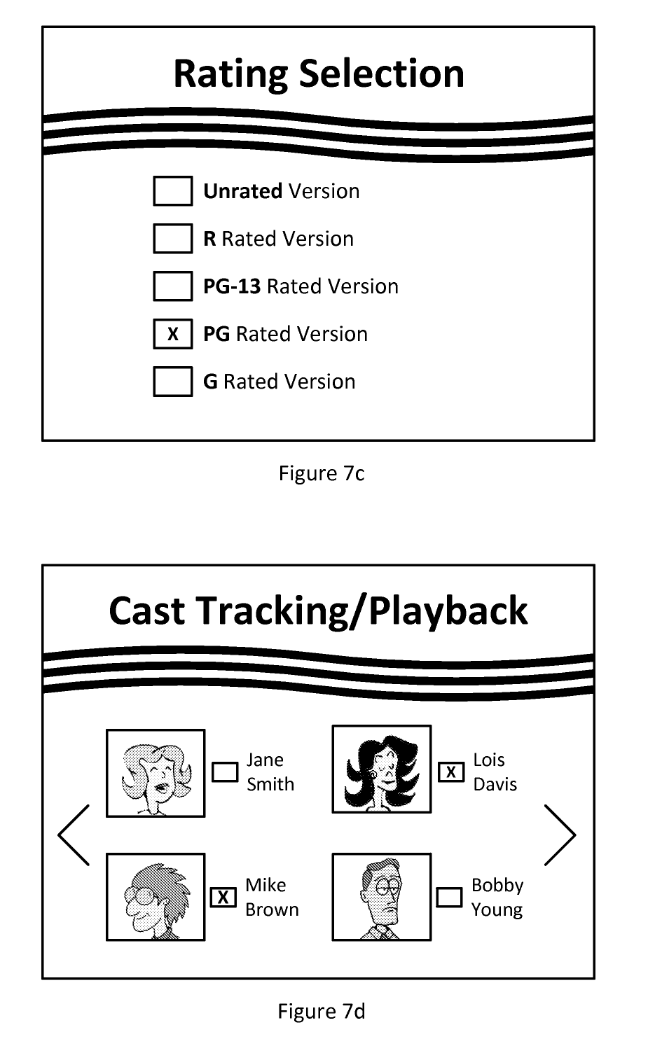

FIGS. 7a-7d illustrate example screen shots of a user interface for selecting one or more smart playback options, in accordance with an embodiment of the present invention. FIG. 7a shows an example main menu screen for a video, such as the main menu screen when playing a DVD movie. The options on this screen include typical main menu screen selection options, such as play video, chapter index, subtitles, and credits. However, in addition to such typical choices, the main menu of this example smart playback user interface is configured to present a smart playback options choice to allow a user to enter the smart playback options sub-menu. If the user selects the smart playback options sub-menu, it may take the user to a selection screen as shown in FIG. 7b. As will be appreciated, such a smart playback options screen may include any number of smart playback options; however, the available options in this example embodiment include: rating selection (allowing the user to adjust playback based on the selected movie rating); actor/actress playback (allowing the user to adjust playback based on one or more selected actors/actresses); and scene-by-scene person, object, and phrase searches (allowing the user to search/scan the movie for one or more selected persons, objects, or phrases, respectively).

If the rating selection smart playback option is selected, it may take the user to another sub-menu or user interface screen as shown in FIG. 7c. As previously described, each movie rating may be assigned a distinct tag allowing for each scene of the movie to be rated using the smart encoding techniques described herein or using manual tagging-data generation by, for example, the movie producer. The breakdown of each scene by rating allows the user to select the preferred viewing option based on the movie rating, as shown in the example screen shot of FIG. 7c. For example, the unrated version of the movie may show every scene, whereas a first set of scenes may be excluded for the R rated version, the first set and a second set of scenes may be excluded for the PG-13 rated version, and so on. Therefore, the tagging-data used for the smart video playback allows for multiple different smart playback options using only one encoded media stream. In this instance, the PG rated version of the movie has been selected.

If the actor/actress playback smart playback option is selected from the example sub-menu shown in FIG. 7b, it may take the user to another sub-menu or screen shot as shown in FIG. 7d. This screen allows the user to select to view only the scenes of the movie that contain the one or more selected actors/actresses. The available actors/actresses in this screen are Jane Smith, Lois Davis, Mike Brown, and Bobby Young. The face images associated with each person (tag) may be provided to the sub-menu as shown in numerous different ways, such as by including face image files (reference data files) for each person (tag) with the tagging-data or by extracting the images from the encoded media, for example. In this instance, the user has selected to view the movie following only Lois Davis and Mike Brown. Therefore, the movie playback will only contain the scenes where Lois Davis and Mike Brown are present. The embodiments, however, are not limited to the selection screens or context shown or described in FIGS. 7a-7d.

Example System

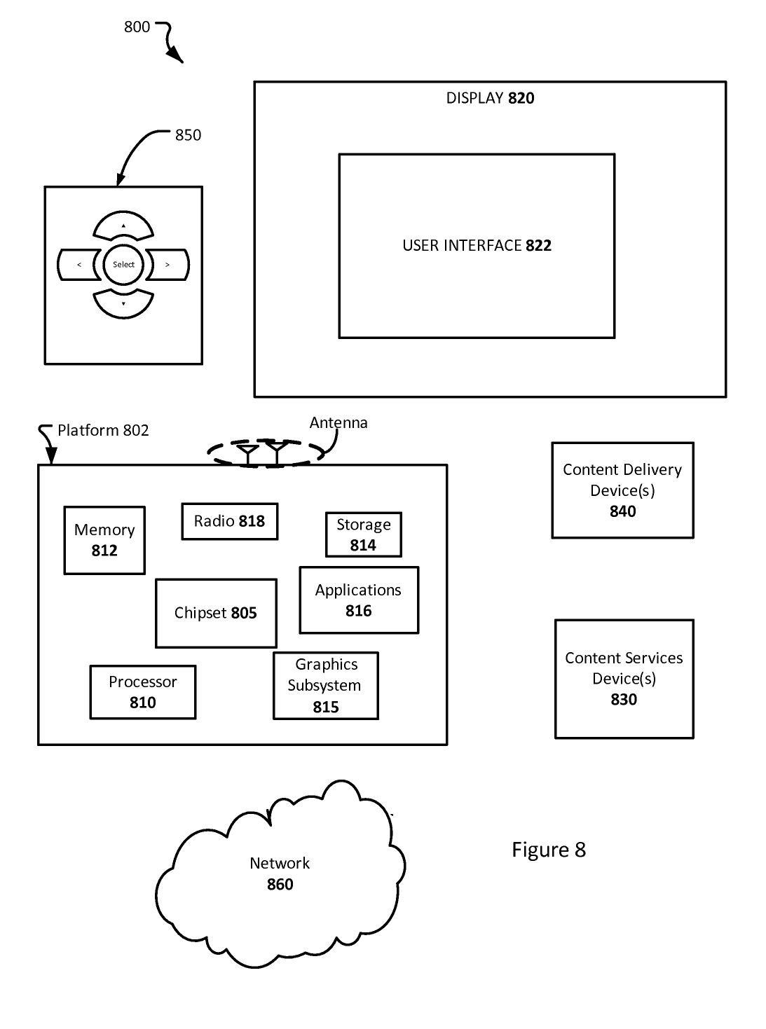

FIG. 8 illustrates an example system 800 that may carry out a smart encoding technique and/or a smart decoding technique as described herein, in accordance with some embodiments. In some embodiments, system 800 may be a media system although system 800 is not limited to this context. For example, system 800 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, set-top box, game console, or other such computing environments capable of performing graphics rendering operations.

In some embodiments, system 800 comprises a platform 802 coupled to a display 820. Platform 802 may receive content from a content device such as content services device(s) 830 or content delivery device(s) 840 or other similar content sources. A navigation controller 850 comprising one or more navigation features may be used to interact with, for example, platform 802 and/or display 820. Each of these example components is described in more detail below.

In some embodiments, platform 802 may comprise any combination of a chipset 805, processor 810, memory 812, storage 814, graphics subsystem 815, applications 816 and/or radio 818. Chipset 805 may provide intercommunication among processor 810, memory 812, storage 814, graphics subsystem 815, applications 816 and/or radio 818. For example, chipset 805 may include a storage adapter (not depicted) capable of providing intercommunication with storage 814.

Processor 810 may be implemented, for example, as Complex Instruction Set Computer (CISC) or Reduced Instruction Set Computer (RISC) processors, x86 instruction set compatible processors, multi-core, or any other microprocessor or central processing unit (CPU). In some embodiments, processor 810 may comprise dual-core processor(s), dual-core mobile processor(s), and so forth. Memory 812 may be implemented, for instance, as a volatile memory device such as, but not limited to, a Random Access Memory (RAM), Dynamic Random Access Memory (DRAM), or Static RAM (SRAM). Storage 614 may be implemented, for example, as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In some embodiments, storage 814 may comprise technology to increase the storage performance enhanced protection for valuable digital media when multiple hard drives are included, for example.

Graphics subsystem 815 may perform processing of images such as still or video for display. Graphics subsystem 815 may be a graphics processing unit (GPU) or a visual processing unit (VPU), for example. An analog or digital interface may be used to communicatively couple graphics subsystem 815 and display 820. For example, the interface may be any of a High-Definition Multimedia Interface, DisplayPort, wireless HDMI, and/or wireless HD compliant techniques. Graphics subsystem 815 could be integrated into processor 810 or chipset 805. Graphics subsystem 815 could be a stand-alone card communicatively coupled to chipset 805. The smart encoding and/or smart decoding techniques described herein may be implemented in various hardware architectures. For example, a TD-enabled encoder and/or decoder as provided herein may be integrated within a graphics and/or video chipset. Alternatively, a discrete security processor may be used. In still another embodiment, the graphics and/or video functions including smart encoding and/or smart decoding may be implemented by a general purpose processor, including a multi-core processor.

Radio 818 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 818 may operate in accordance with one or more applicable standards in any version.

In some embodiments, display 820 may comprise any television or computer type monitor or display. Display 820 may comprise, for example, a liquid crystal display (LCD) screen, electrophoretic display (EPD or liquid paper display, flat panel display, touch screen display, television-like device, and/or a television. Display 820 may be digital and/or analog. In some embodiments, display 820 may be a holographic or three-dimensional display. Also, display 820 may be a transparent surface that may receive a visual projection. Such projections may convey various forms of information, images, and/or objects. For example, such projections may be a visual overlay for a mobile augmented reality (MAR) application. Under the control of one or more software applications 816, platform 802 may display a user interface 822 on display 820.

In some embodiments, content services device(s) 830 may be hosted by any national, international and/or independent service and thus accessible to platform 802 via the Internet or other network, for example. Content services device(s) 630 may be coupled to platform 802 and/or to display 820. Platform 802 and/or content services device(s) 830 may be coupled to a network 860 to communicate (e.g., send and/or receive) media information to and from network 860. Content delivery device(s) 840 also may be coupled to platform 802 and/or to display 820. In some embodiments, content services device(s) 830 may comprise a cable television box, personal computer, network, telephone, Internet enabled devices or appliance capable of delivering digital information and/or content, and any other similar device capable of unidirectionally or bidirectionally communicating content between content providers and platform 802 and/display 820, via network 860 or directly. It will be appreciated that the content may be communicated unidirectionally and/or bidirectionally to and from any one of the components in system 800 and a content provider via network 860. Examples of content may include any media information including, for example, video, music, graphics, text, medical and gaming content, and so forth.

Content services device(s) 830 receives content such as cable television programming including media information, digital information, and/or other content. Examples of content providers may include any cable or satellite television or radio or Internet content providers. The provided examples are not meant to limit the claimed invention. In some embodiments, platform 802 may receive control signals from navigation controller 850 having one or more navigation features. The navigation features of controller 850 may be used to interact with user interface 822, for example. In some embodiments, navigation controller 850 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 850 may be echoed on a display (e.g., display 820) by movements of a pointer, cursor, focus ring, or other visual indicators displayed on the display. For example, under the control of software applications 816, the navigation features located on navigation controller 850 may be mapped to virtual navigation features displayed on user interface 822, for example. In some embodiments, controller 850 may not be a separate component but integrated into platform 802 and/or display 820. Embodiments, however, are not limited to the elements or in the context shown or described herein, as will be appreciated.

In some embodiments, drivers (not shown) may comprise technology to enable users to instantly turn on and off platform 802 like a television with the touch of a button after initial boot-up, when enabled, for example. Program logic may allow platform 802 to stream content to media adaptors or other content services device(s) 830 or content delivery device(s) 840 when the platform is turned “off.” In addition, chip set 805 may comprise hardware and/or software support for 5.1 surround sound audio and/or high definition 7.1 surround sound audio, for example. Drivers may include a graphics driver for integrated graphics platforms. In some embodiments, the graphics driver may comprise a peripheral component interconnect (PCI) express graphics card.

In various embodiments, any one or more of the components shown in system 800 may be integrated. For example, platform 802 and content services device(s) 830 may be integrated, or platform 802 and content delivery device(s) 840 may be integrated, or platform 802, content services device(s) 830, and content delivery device(s) 840 may be integrated, for example. In various embodiments, platform 802 and display 820 may be an integrated unit. Display 820 and content service device(s) 830 may be integrated, or display 820 and content delivery device(s) 840 may be integrated, for example. These examples are not meant to limit the claimed invention.

In various embodiments, system 800 may be implemented as a wireless system, a wired system, or a combination of both. When implemented as a wireless system, system 800 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 800 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 802 may establish one or more logical or physical channels to communicate information. The information may include media information and control information. Media information may refer to any data representing content meant for a user. Examples of content may include, for example, data from a voice conversation, videoconference, streaming video, email or text messages, voice mail message, alphanumeric symbols, graphics, image, video, text and so forth. Control information may refer to any data representing commands, instructions or control words meant for an automated system. For example, control information may be used to route media information through a system, or instruct a node to process the media information in a predetermined manner (e.g., using smart encoding and/or smart decoding techniques as described herein). The embodiments, however, are not limited to the elements or context shown or described in FIG. 8.

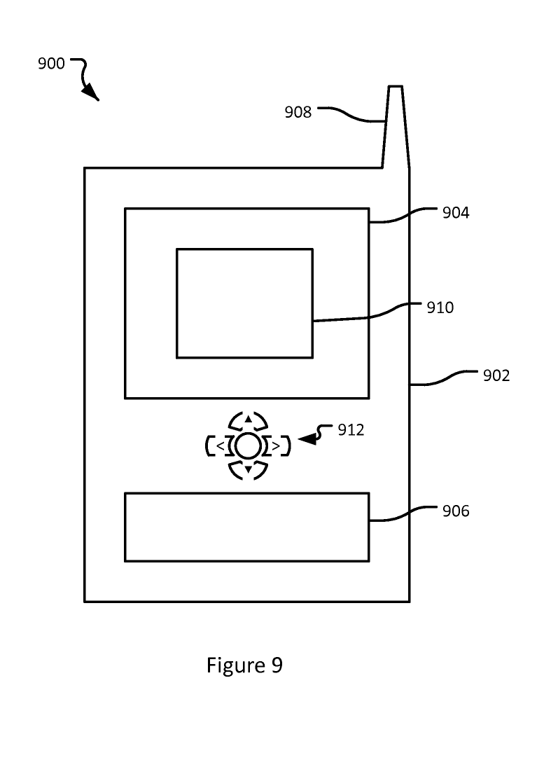

As described above, system 800 may be embodied in varying physical styles or form factors. FIG. 9 illustrates embodiments of a small form factor device 900 in which system 800 may be embodied. In some embodiments, for example, device 900 may be implemented as a mobile computing device having wireless capabilities. A mobile computing device may refer to any device having a processing system and a mobile power source or supply, such as one or more batteries, for example.

As previously described, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In some embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 9, device 900 may comprise a housing 902, a display 904, an input/output (I/O) device 906, and an antenna 908. Device 900 also may comprise navigation features 912. Display 904 may comprise any suitable display unit for displaying information appropriate for a mobile computing device. I/O device 906 may comprise any suitable I/O device for entering information into a mobile computing device. Examples for I/O device 906 may include an alphanumeric keyboard, a numeric keypad, a touch pad, input keys, buttons, switches, rocker switches, microphones, speakers, voice recognition device and software, and so forth. Information also may be entered into device 900 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Whether hardware elements and/or software elements are used may vary from one embodiment to the next in accordance with any number of factors, such as desired computational rate, power levels, heat tolerances, processing cycle budget, input data rates, output data rates, memory resources, data bus speeds and other design or performance constraints.

Some embodiments may be implemented, for example, using a machine-readable medium or article which may store an instruction or a set of instructions that, if executed by a machine, may cause the machine to perform a method and/or operations in accordance with an embodiment of the present invention. Such a machine may include, for example, any suitable processing platform, computing platform, computing device, processing device, computing system, processing system, computer, processor, or the like, and may be implemented using any suitable combination of hardware and software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of executable code implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or displays. The embodiments are not limited in this context.

Numerous variations and embodiments will be apparent in light of this disclosure. One example embodiment of the present invention provides a computer readable medium encoded with instructions that when executed by one or more processors cause a process to be carried out. The process includes receiving one or more raw media streams, receiving reference data to be located within the one or more media streams, estimating matches between the reference data and the one or more media streams to identify location information for one or more tags, wherein the one or more tags are individually identified by a tag index, and generating tagging-data based on the tag index and location information for the one or more tags, wherein the tagging-data enables content sensitive playback. In some cases, at least one of the estimating and generating may be executable by a graphics processing unit (GPU). In some instances, the generated tagging-data may be embedded in an encoded media stream. In some other instances, the tagging-data may be generated as a supplementary stream. In some embodiments, the reference data may be stored in one or more reference stores. In some cases, the process may further include the preliminary steps of receiving encoded media, and decoding the encoded media to form the one or more raw media streams. In some instances the matches to identify location information for one or more tags may be found when an estimate is greater than a predetermined threshold. In some embodiments, the tag location information may be identified at one of a whole media, media sequence, frame, and frame macroblock level. In some cases, the reference data may be extracted from the one or more media streams.

Another embodiment of the present invention provides a computer readable medium encoded with instructions that when executed by one or more processors cause a process to be carried out. The process includes receiving one or more encoded media streams, receiving tagging-data associated with the one or more encoded media streams, parsing the tagging-data to provide one or more smart media playback options, receiving one or more user requests, wherein the one or more user requests selects a smart media playback option, and outputting the selected smart media playback option so as to allow content sensitive playback. In some cases, at least one of the parsing and outputting may be executable by a graphics processing unit (GPU). In some instances, the tagging-data may be embedded in the encoded media streams. In some other instances, the tagging-data may be received as a supplementary stream. In some embodiments, the smart playback options may include frame-selective playback of media based on one or more selected tags.

Another embodiment of the present invention provides a tagging-data (TD)-enabled encoding device, including a match estimation module configured to receive one or more raw media streams and reference data to be located within the one or more media streams, and estimate matches between the reference data and the one or more media streams to identify location information for one or more tags, wherein the one or more tags are individually identified by a tag index, and a TD generation module configured to generate tagging-data based on the tag index and location information for the one or more tags, wherein the tagging-data enables content sensitive search. In some cases, the TD-enabled encoding device is a graphics processing unit (GPU). In some instances, a stationary or mobile computing device may include the TD-enabled encoding device.

Another embodiment of the present invention provides a tagging-data (TD)-enabled decoding device, including a TD parsing module configured to receive one or more encoded media streams and tagging-data associated with the one or more encoded media streams, and to parse the tagging-data to provide one or more smart media playback options, a user interface module configured for receiving a user request indicating a selected smart media playback option, and a tag selection module configured to output the selected smart media playback option so as to allow content sensitive playback. In some cases, the TD-enabled decoding device is a graphics processing unit (GPU). In some instances, a media playback system may include the TD-enabled decoding device.

Note that reference to multiple different modules herein is not intended to imply distinct modules. For instance, in some cases, the match estimation module and the TD generation module may be the same module or its functions may be performed by the same software/hardware/firmware. Also note, as previously described, the TD-enabled encoder and TD-enabled decoder may be contained within the same software/hardware/firmware and thus the same software/hardware/firmware may be capable of performing the functions of both.

The foregoing description of example embodiments of the invention has been presented for the purposes of illustration and description. It is not intended to be exhaustive or to limit the invention to the precise forms disclosed. Many modifications and variations are possible in light of this disclosure. It is intended that the scope of the invention be limited not by this detailed description, but rather by the claims appended hereto.

What is claimed is:

1. A computer readable medium encoded with instructions that when executed by one or more processors cause a process to be carried out, the process comprising:
receiving one or more raw media streams;
receiving reference data to be located within the one or more media streams;
estimating matches between the reference data and the one or more media streams to identify location information for one or more tags, wherein the one or more tags are individually identified by a tag index; and
generating tagging-data based on the tag index and location information for the one or more tags, wherein the tagging-data enables content sensitive playback.

2. The computer readable medium of claim 1 wherein at least one of the estimating and generating are executable by a graphics processing unit (GPU).

3. The computer readable medium of claim 1 wherein the generated tagging-data is embedded in an encoded media stream.

4. The computer readable medium of claim 1 wherein the tagging-data is generated as a supplementary stream.

5. The computer readable medium of claim 1 wherein the reference data is stored in one or more reference stores.

6. The computer readable medium of claim 1, the process further comprising the preliminary steps of:
receiving encoded media; and
decoding the encoded media to form the one or more raw media streams.

7. The computer readable medium of claim 1 wherein matches to identify location information for one or more tags are found when an estimate is greater than a predetermined threshold.

8. The computer readable medium of claim 1 wherein the tag location information is identified at one of a whole media, media sequence, frame, or frame macroblock level.

9. The computer readable medium of claim 1 wherein the reference data is extracted from the one or more media streams.

10. A computer readable medium encoded with instructions that when executed by one or more processors cause a process to be carried out, the process comprising:
receiving one or more encoded media streams;
receiving tagging-data associated with the one or more encoded media streams;
parsing the tagging-data to provide one or more smart media playback options;
receiving one or more user requests, wherein the one or more user requests selects a smart media playback option; and
outputting the selected smart media playback option so as to allow content sensitive playback.

11. The computer readable medium of claim 10 wherein at least one of the parsing and outputting are executable by a graphics processing unit (GPU).

12. The computer readable medium of claim 10 wherein the tagging-data is embedded in the encoded media streams.

13. The computer readable medium of claim 10 wherein the tagging-data is received as a supplementary stream.

14. The computer readable medium of claim 10 wherein the smart playback options include frame-selective playback of media based on one or more selected tags.

15. A tagging-data (TD)-enabled encoding device, comprising:
a match estimation module configured to receive one or more raw media streams and reference data to be located within the one or more media streams, and estimate matches between the reference data and the one or more media streams to identify location information for one or more tags, wherein the one or more tags are individually identified by a tag index; and
a TD generation module configured to generate tagging-data based on the tag index and location information for the one or more tags, wherein the tagging-data enables content sensitive search.

16. The device of claim 15 wherein the TD-enabled encoding device is a graphics processing unit (GPU).

17. A stationary or mobile computing device comprising the device of claim 15.

18. A tagging-data (TD)-enabled decoding device, comprising:
a TD parsing module configured to receive one or more encoded media streams and tagging-data associated with the one or more encoded media streams, and to parse the tagging-data to provide one or more smart media playback options;
a user interface module configured for receiving a user request indicating a selected smart media playback option; and
a tag selection module configured to output the selected smart media playback option so as to allow content sensitive playback.

19. The device of claim 18 wherein the TD-enabled decoding device is a graphics processing unit (GPU).

20. A media playback system comprising the device of claim 18.
